(19) United States
(12) Patent Application Publication
(10) Pub. No.: US 2024/0071249 A1
(43) Pub. Date: Feb. 29, 2024

(54) System, Apparatus and Method for Advance View Limiting Device

(71) Applicant: Shahriar SHAMS, Whittier, CA (US)

(72) Inventor: Shahriar SHAMS, Whittier, CA (US)

(21) Appl. No.: 17/900,834

(22) Filed: Aug. 31, 2022

(51) Int. Cl. G09B 9/36; G09B 9/44

(52) U.S. Cl. CPC G09B 9/36; G09B 9/44; G06F 3/012

(57) ABSTRACT

Advance View Limiting Device (AVLD) is a system, apparatus and method that simulates instrument meteorological condition (IMC) by replacing the pilot's “outside the aircraft” view with recorded videos or high-definition computer generated images of various poor visibility conditions for the purpose of pilot instrument training, practice and evaluation.

A method and a system of presenting augmented images on augmented reality goggles, the method comprising the steps of: accessing defined augmented images of weather phenomenon, receiving desired geographical boundaries and desired altitude boundaries; using the geographical boundaries, and the altitude boundaries to determine a defined volumetric space, receiving three-dimensional location information related to position of an aircraft in operation; wherein the augmented reality goggles are located inside the aircraft, determining that said three-dimensional location information is positioned within said defined volumetric space, and displaying augmented images on said augmented reality goggles.

### TECHNICAL FIELD

The present disclosure relates to electronics and aviation.

### BACKGROUND OF THE INVENTION

Flight within the National Airspace System of the United States operates under either Visual Flight Rules (VFR) or Instrument Flight Rules (IFR). Pilots can operate under VFR or IFR in Visual Meteorological Conditions (VMC), but pilots must only operate under IFR in Instrument Meteorological Conditions (IMC). Minimum VFR conditions require a cloud ceiling of at least 1,000 feet above ground level (AGL) and a ground visibility of at least 3 statute miles. The “ceiling” is defined to be the height of the base of the lowest level of clouds with respect to the terrain below it—so in other words, the height at which cloud cover begins. When the minimum VFR conditions are not present, the pilot must be IFR rated—rated to fly in IFR conditions. Flying under IFR conditions requires the pilot to rely on the instruments of the aircraft rather than visual observations made by the pilot. Understandably, learning to rely on the instruments of an aircraft to fly requires “instrument training”. Instrument training is one of the challenging areas of pilot training. The main purpose behind instrument training is to train pilots to be able to fly the aircraft in Instrument Meteorological Condition (IMC) where there is no outside reference available for attitude, altitude, heading and location. Examples of Instrument Meteorological Conditions are flying in clouds, fog, and extreme darkness over ocean or desert where the horizon is not recognizable. Poor visibility always results in loss of attitude reference which causes the pilot to incorrectly interpret the aircraft's attitude, altitude, heading or airspeed. This phenomenon is known as Spatial Disorientation, and it is among the major causes for loss of control in flight.

VFR Pilots seeking instrument rating or instrument rated pilots (both referred to herein as “student” for ease of reference) who want to maintain their instrument currency, both require frequent simulated instrument training time. The term “simulated instrument time” is defined as the time that student experiences flying in a simulated instrument condition in an approved flight simulator or flying in an actual aircraft in Visual Meteorological Conditions (VMC) while using a view limiting device. The student who wishes to have simulated instrument time in actual aircraft must wear a view limiting device throughout the entire duration of flight (except during takeoffs and landings). Also, the flight should only be conducted while the other control seat in the cockpit (with access to flight controls and flight instruments) is occupied by a Certified Flight Instructor for Instrument (CFII), a Safety Pilot, a Designated Pilot Examiner (DPE), or an FAA Inspector (all referred to herein as the “Safety Pilot” for ease of reference).

FIG. 1 illustrates the inside of a cockpit where the student 105 is wearing a view limiting device commonly known as Foggles® 110 and a Safety Pilot 115 is present. FIG. 2 illustrates the Inside of a cockpit where the student 105 is wearing a different type of view limiting device commonly known as IFR Hood 205 and a Safety Pilot 115 is present. Foggles® are made of lenses that are partially opaque or translucent intended to partially block the side pictures of the student and to limit their sight mostly to the aircraft's instrument panel. Regardless of whether the student uses Foggles® or IFR hood, the idea is that the student wears a view limiting device 110 or 205 to simulate absence of outside references. This should force the student to interpret the aircraft's attitude, altitude, heading and location by evaluating the information provided by the flight instruments as well as navigation instruments.

One of the main problems with the existing view limiting devices is that the student's 105 subconscious mind can still recognize attitude, altitude, heading and location by receiving reference information through the peripheral vision (since the lower corners of most view limiting devices are open). Intentionally or unintentionally, the student 105 using one of these view limiting devices 110 or 205 often gets helped from the observations made by way of their peripheral vision. These observations by way of the student's peripheral vision makes it easier for the student to control and navigate the aircraft.

Training in a simulator reduces or eliminates the student's ability to rely on peripheral vision, but it comes at the price of not flying an actual aircraft. Flying an actual aircraft always involves complexities and risks associated with many other factors including but not limited to collision avoidance (with obstacles and other traffics), communications with Air Traffic Controller (ATC), possible medical issues associated with air travel, possible malfunctions of aircraft systems and possible emergencies that may be encountered. When these other factors are present, they ensure that the cockpit environment is significantly more intense and demanding than time spent in a simulator. For the best training and preparation, a student must be able to perform and practice all of the duties an instrument rated pilot may encounter while dealing with the intense cockpit environment. Prior to the present invention, the highest quality of instrument training is only achievable if students can experience and practice the factors mentioned above during actual flight in IMC.

Unfortunately, instrument training cannot always be done in IMC due to higher risks that need to be taken by the student, the instructor, and the air traffic controller. Weather limitations or geographical location are also other reasons that may limit the amount of time available to fly under IMC. Even if the geographical location offers instrument meteorological conditions on a routine basis, it is often accompanied by hazardous weather such as thunderstorms, heavy rain, hail, or other significant meteorological conditions. In addition, training in IMC requires the flight to be conducted under Instrument Flight Rules (IFR) which adds an additional responsibility and restrictions for both the student, the instructor, and air traffic controller. Therefore, many flight instructors avoid training in IMC unless the student exhibits acceptable instrument flying skills. In any case, training in IMC will still be limited to maneuvers necessary to conduct an IFR flight. Exercising maneuvers such as simulated engine failure, stall, or spin is strictly prohibited in actual instrument condition and it is currently a gap in instrument training. After all, VFR pilots who are undergoing IFR training are lucky if they even experience a few hours of flying in actual IMC throughout their entire training, while many others experience none.

### SUMMARY OF THE INVENTION

The invention includes a method of presenting augmented images on augmented reality goggles, the method comprising the steps of: accessing defined augmented images of weather phenomenon, receiving desired geographical boundaries and desired altitude boundaries; using the geographical boundaries, and the altitude boundaries to determine a defined volumetric space, receiving three-dimensional location information related to position of an aircraft in operation; wherein the augmented reality goggles are located inside the aircraft, determining that said three-dimensional location information is positioned within said defined volumetric space, and displaying augmented images on said augmented reality goggles.

The invention includes a method of presenting an “outside the aircraft” view on augmented reality goggles, the method comprising the steps of: accessing the user defined augmented images of a weather phenomenon, receiving desired geographical boundaries and desired altitude boundaries; using the desired geographical boundaries and desired altitude boundaries to determine a defined volumetric space, receiving three-dimensional location information related to position of the aircraft in operation; wherein said augmented reality goggles are located inside the aircraft, and determining that the three-dimensional location is not positioned within the defined volumetric space, and not displaying an augmented image on said augmented reality goggles.

The invention includes an advanced view limiting device comprising: augmented reality goggles, an Automatic Dependent Surveillance Broadcast (ADS-B), a Global Positioning System (GPS), an Attitude, Heading Reference System (AHRS), and a processing unit wherein the processing unit accesses the user defined augmented images of a weather phenomenon, desired geographical boundaries and desired altitude boundaries using the geographical boundaries and altitude boundaries to determine a defined volumetric space, wherein the processing unit receives data from the GPS, or the aircraft's avionics and the processing unit uses data received from the GPS or the aircraft's avionics to determine if the aircraft is located within the defined volumetric space, and if the aircraft is located within the defined volumetric space to use the augmented images of the weather phenomenon to present the augmented images on the augmented reality goggles.

### BRIEF DESCRIPTION OF THE DRAWINGS

The drawings are meant to illustrate the principles of the invention and do not limit the scope of the invention. The above-mentioned features and objects of the present disclosure will become more apparent with reference to the following description taken in conjunction with the accompanying drawings wherein like reference numerals denote like elements in which:

FIG. 1 illustrates the inside of a cockpit where the student is wearing a view limiting device commonly known as Foggles® and a Safety Pilot is present;

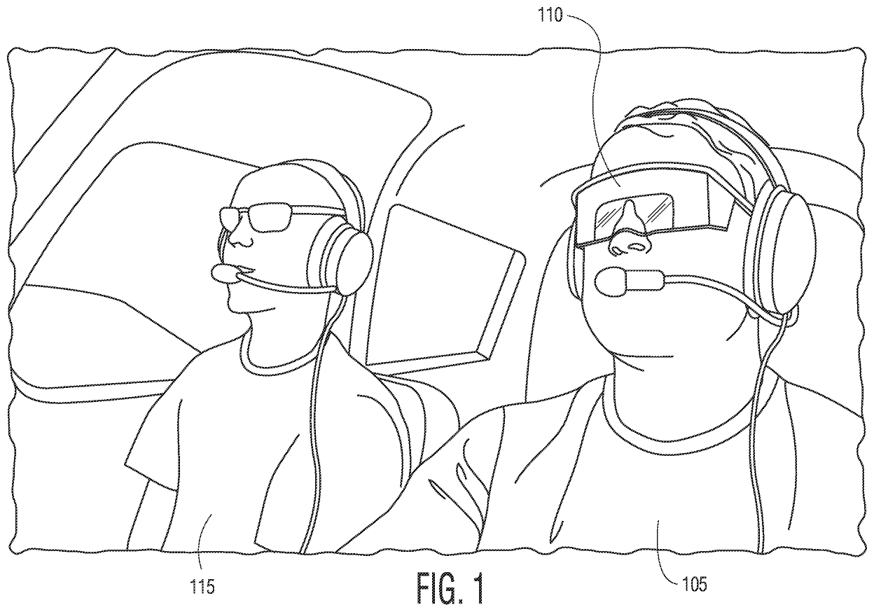

FIG. 2 illustrates the inside of a cockpit where the student is wearing a view limiting device commonly known as IFR Hood and a Safety Pilot is present;

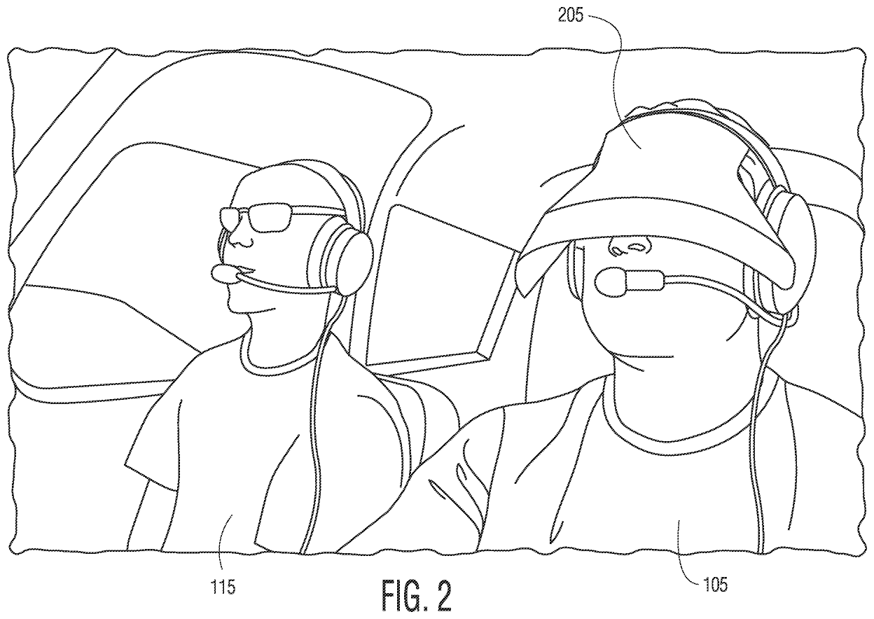

FIG. 3 illustrates student's view through the AR goggles outside the defined volumetric space;

FIG. 4 illustrates student's view through the AR goggles within the defined volumetric space;

FIG. 5 illustrates one embodiment of the Advance View Limiting Device (AVLD) apparatus;

FIG. 6 illustrates the frame of reference for the user's head movement in 3-dimensional space

FIG. 7 illustrates the frame of reference for the aircraft's movement in 3-dimensional space;

FIG. 8 depicts a possible processing sequence and logic diagram of the Advance View Limiting Device;

FIG. 9 illustrates the goggles being worn by the student, and

FIGS. 10A and 10B illustrate one manner in which the invention only presents the augmented images in the appropriate locations on the goggles display.

### DETAILED DESCRIPTION OF THE INVENTION

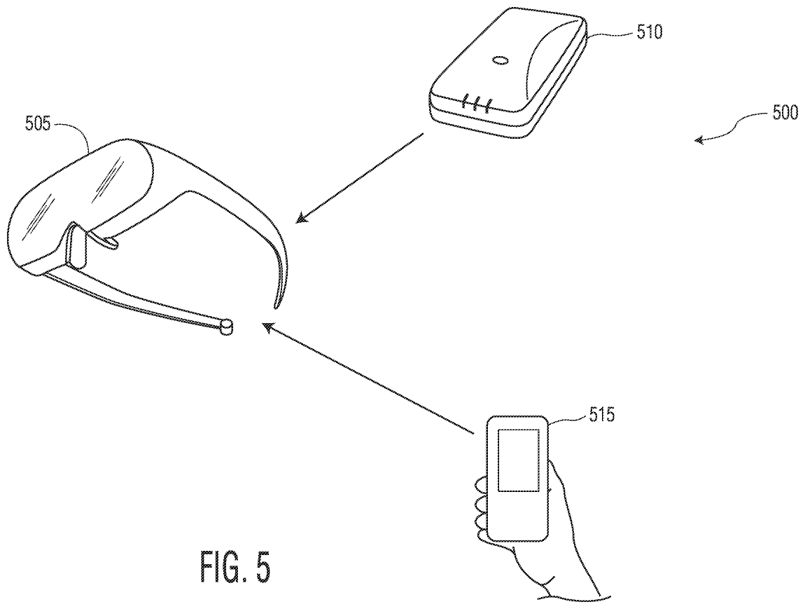

Advance View Limiting Device (AVLD) 500 (FIG. 5) is a system, apparatus and method that simulates instrument meteorological condition (IMC) by replacing the user's “outside the aircraft” view with recorded videos or high definition computer generated images of various poor visibility conditions (all referred to herein as the “Augmented images” for ease of reference) for the purpose of pilot instrument training, practice and evaluation. In one embodiment, AVLD 500 (FIG. 5) consists of: (1) an Augmented Reality (AR) goggles 505 (FIG. 5) (with an internal built-in Attitude, Heading Reference System (AHRS) unit), (2) an ADS-B, GPS & AHRS (AGA) combined unit 510 (ADS-B, GPS & AHRS combined unit), and (3) a processing unit, which may be contained, for example in various embodiments, the processing unit can be imbedded in the goggles, in a stand-alone device, or even in a user's smart device 515 such as a smartphone. In one embodiment, a customized application allows the user to apply settings to AVLD via a personal smart device 515, such as a cellular phone.

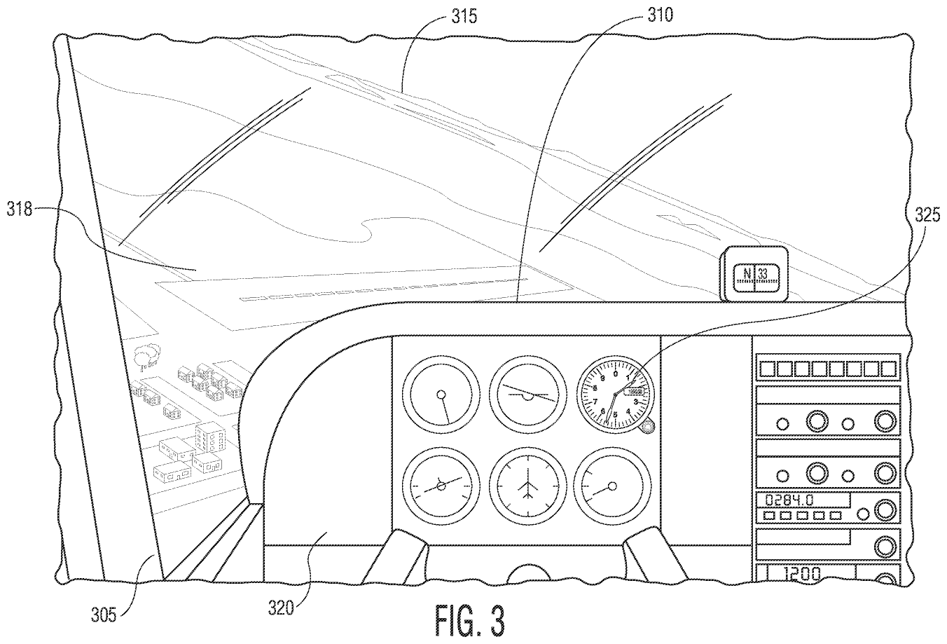

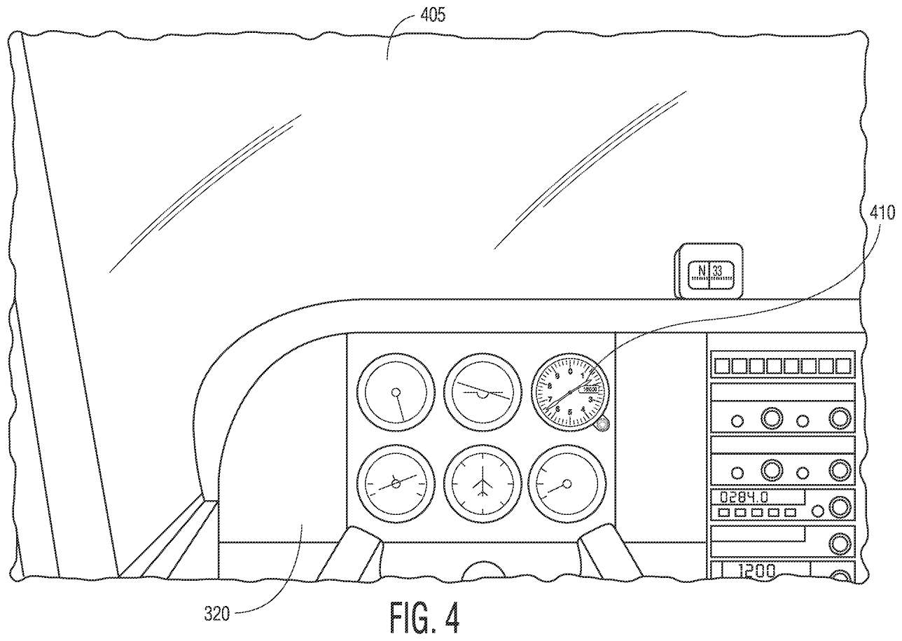

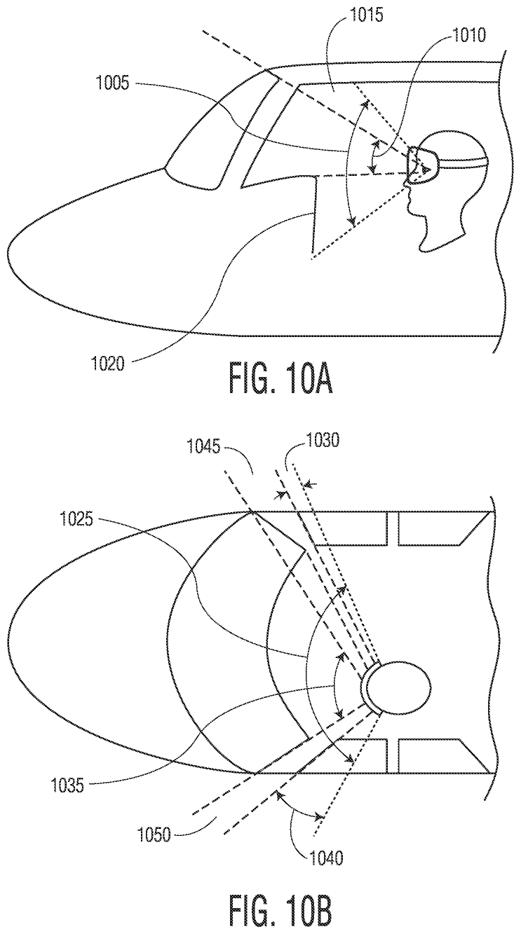

In a preferred embodiment, to use AVLD the student must wear the AR goggles 505 and be seated on the seat of either the pilot or co-pilot of an aircraft and the AVLD system 500 must be powered ON. In this situation, the AR goggles 505 will automatically (preferably) start recognizing the boundaries of “outside the aircraft” view 318 (FIG. 3) that are observable from the point of view of the student 105 (all referred to herein as the “aircraft's window frames” for ease of reference). Once the boundaries of “aircraft's window frames” 305 are detected, the AR goggles 505 will track the detected boundaries regardless of the student's head movements. One of ordinary skill in the art would appreciate that the boundaries of the “aircraft's window frames” is but one reference system that may be used to practice the invention. Other reference systems such as, and not limited to, the top of the dashboard of the 310 (FIG. 3) cockpit may be used and these other reference points are included within the scope of the present invention. The safety pilot 115 then preferably uses the customized smart device application to select a desired augmented images of a weather phenomenon (for example, cloud, fog, sleet, hail, rain, etc.) saved on a memory, desired geographical boundaries and desired altitudes for the top and base (ceiling) of the phenomenon to be displayed. The AVLD 500 then replaces the observable images the student would normally view through the “aircraft's window frames” 305 (FIG. 3) with the recorded videos or high-definition computer generated images viewed 405 (FIG. 4) through the AR goggles 505 and within the defined boundaries of “outside the aircraft” view. Refer to FIGS. 10A and 10B and the related descriptions for further clarification. FIG. 4 illustrates the student's view through the AR goggles 505 within the defined volumetric space. Inside of the defined volumetric space means that the aircraft is flying above the ceiling, below the top of the clouds, and within the geographic boundaries selected for the weather phenomenon. During this time, the student 105 can see instrument panels 320, switches and everything else inside the aircraft through the AR goggles 505 the same as it can be seen with naked eyes. This creates a unique condition as if the student 105 is flying the aircraft in IMC, while the safety pilot 115 enjoys excellent visibility of the VFR condition.

FIG. 3 illustrates the student's view through the AR goggles 505 outside of the defined volumetric space. Outside of the defined volumetric space means that the aircraft is flying below the ceiling, above the top of the clouds, or outside of the geographic boundaries selected. If the aircraft descends below the ceiling set point or climbs above the top set point for the phenomenon, or the aircraft exits the predetermined geographical boundaries of the phenomenon, the augmented images 405 will smoothly fade away from the student's central vision towards far peripheral vision as if the aircraft truly transitioned from IMC to VMC. Even when the aircraft is located outside the defined volumetric space (i.e., the geographical boundaries and the altitudes for the top and ceiling of the phenomenon) defined by the safety pilot 115, the AR goggles 505 may still provide augmented images 405 on the student's peripheral vision depending on aircraft's attitude, altitude and heading. For example, if the aircraft descents below the ceiling set point, the augmented images (of cloud for example) will fade away from the student's central vision and will be moved towards student's top far peripheral vision, as if the aircraft is really flying below an overcast layer of clouds. In addition to this, the AVLD system 500 automatically compares the position of augmented images on the goggle's display with, for example, the “aircraft's window frames” and adjusts them to ensure precise replacement of “aircraft's outside” view of the pilot is achieved regardless of pilot's head movements. See reference numbers 1010 1030, 1035 and 1040 in FIGS. 10A and 10B. Refer to FIGS. 10A and 10B and the related descriptions for further clarification. The AVLD system 500 also automatically compares and adjusts the speed at which the augmented images 405 are being played with respect to the aircraft's airspeed in order to create the most realistic experience for the student. For example, if the augmented images 405 shown are broken clouds or snow particles impacting the front screen, the augmented images 405 are shown at the same (or nearly the same) speed as if the aircraft was flying into the same conditions in reality. Similarly, the AVLD system 500 automatically compares and adjusts the orientation of the augmented images with respect to fixed references in spaces (such as horizon or a fixed heading reference, or both) so that the orientation of augmented images will appear the most realistic during cruise, climb, descent and turn. The AVLD 500 can also record and store the student's view (through the goggle) on, for example, the AR goggles' 505 memory for education and debriefing purposes. The student's 105 view thought the AR goggles 505 can also be monitored on demand through the smart device 515 so that the safety pilot 115 can verify the presence of simulated instrument condition at any moment of time.

FIG. 5 illustrates one embodiment of the Advance View Limiting Device (AVLD) 500 apparatus. For example, using the components depicted in FIG. 5 the safety pilot 115 can apply or change the meteorological conditions “observed” by the student 105 and viewed through the AR goggles 505. Applying or modifying the “observed” meteorological conditions will affect the simulated flying conditions that the student 105 experiences. As one example, the sky condition can be chosen to be overcast with a ceiling at 1,600 feet MSL. One of ordinary skill in the art would appreciate that while the aircraft is above 1,600 feet MSL FIG. 4 410 the AVLD system 500 ensures that the AR goggles 505 show augmented images of flying through the clouds 405 (FIG. 4) through all observable windows while the safety pilot 115 can still have an excellent view of terrain 315 (FIG. 3) and traffic. Once the aircraft descends below 1,600 feet MSL FIG. 3 325 the AVLD system 500 ensures that the augmented images 405 shown through the AR goggles 505 will fade-out from the student's central vision and move towards his/her far peripheral vision. This allows the student 105 to have the same visibility on his/her central vision (see, for example, FIG. 3) as the safety pilot 115. As the aircraft continues to descent, the AVLD system 500 will further moves the augmented images of the cloud ceiling towards the student's top far peripheral vision as if the aircraft is getting further away from the clouds. If the aircraft's attitude, altitude, or heading changes to an extent that the defined volumetric space completely falls outside of “aircraft's window frames”, then the AVLD systems 500 will no longer provide any augmented images on the goggles. Hence, the student will have the same visibility throughout his/her whole field of vision as the safety pilot 115. In a preferred embodiment, the information sent from the combined unit 510 to the AR goggles 505 includes real time ADS-B, GPS and AHRS data. In a preferred embodiment, the information sent from the smart device 515 to the AR goggles 505 includes but not limited to desired weather conditions (type of phenomenon), altitude ranges (top & Ceiling), and desired geographical boundaries.

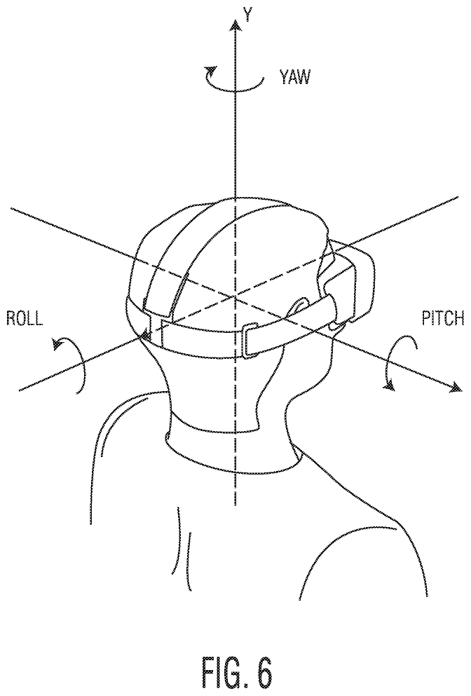

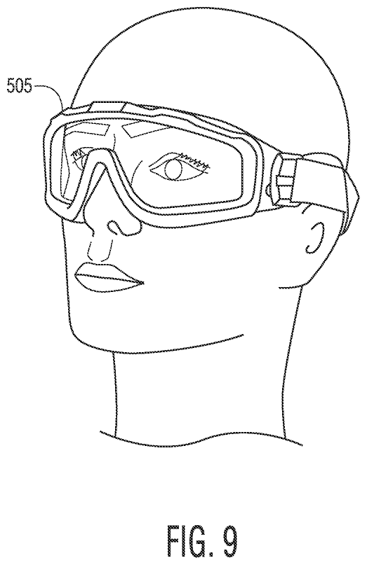

FIG. 6 illustrates the attitude and heading frame of reference for the user's head. While the horizon is typically used as a reference, other references can also be used. One of ordinary skill in the art would understand that AR goggles 505 preferably include two or more cameras (one preferably located on the right corner of the front face of the AR goggles 505 covering the front and a portion of the right peripheral vision, the second camera preferably located on the left corner of the front face of the AR goggles 505 covering the front and a portion of the left peripheral vision), a processing unit, depth and proximity sensors, orientation Sensors, attitude and heading reference system such as AHRS-2, and a display unit. The cameras provide images to the AR goggles' 505 processing unit. Preferably, a copy of these images will be sent to the Graphic Processing Unit (“GPU”) to construct a final visual experience 405. Preferably, another copy is used for detection and tracking of the target boundaries (such as the window frames). One of ordinary skill in the art would know that this can be accomplished by a customized algorithm that is specifically designed to recognize geometric features of various aircraft's interior geometric references (such as window frames) to enable the AVLD 500 to be compatible with all (or most) types of aircrafts. FIG. 9 shows that the sides of the AR goggle 505 are preferably completely closed such that it will not allow any light to penetrate through the sides of the goggles (where the goggles make contact with user's face). Objects and light can only be seen if they are located within the field of vision through the AR goggle's 505.

The information provided by proximity and depth sensors may be used by the AR goggles' 505 processing unit to measure the distances between various points within the cockpit with respect to the position of the AR goggles 505. This information may be used to create a digital representation of the cockpit environment as well as to assist object detection, tracking and image orientation control. Another sensor that may also be involved in the process of tracking and orientation control is the AR goggles' 505 built-in attitude and heading reference system (AHRS) unit such as an AHRS-2. The AHRS-2 measures changes in Pitch, Role, and Yaw of the student's 105 head. The information provided by AHRS-2 may be used to determine the student's 105 head position at any given time. This information may also be used as an additional reference to enhance the quality of the “aircraft's window frames” tracking process. One of ordinary skill in the art would understand the combined effects may enable the AR goggles 505 to automatically detect and track “aircraft's window frames” through the computer vision technology. The AVLD system 500 presents the desired augmented images within the portion of the goggle's display that otherwise “outside the aircraft” could be seen (1010 1030, 1035 and 1040 in FIGS. 10A and 10B).

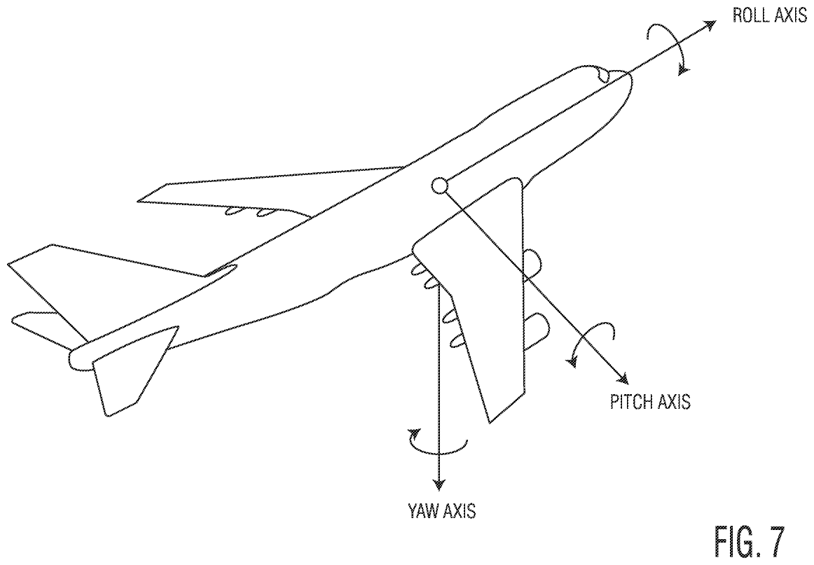

FIG. 7 illustrates an aircraft's heading and attitude plane of reference. One of ordinary skill in the art would readily understand this figure and its teachings and implications.

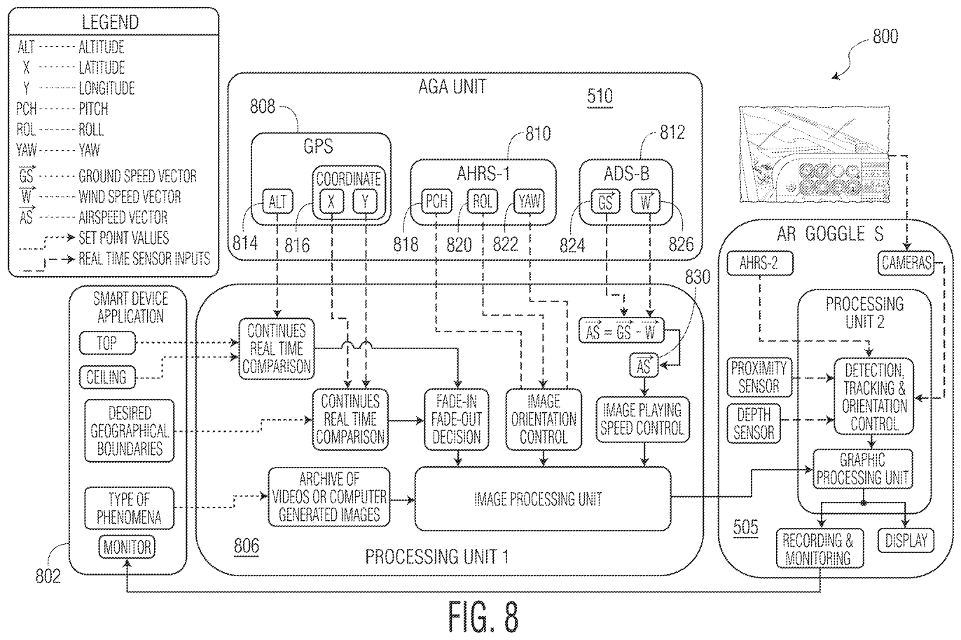

FIG. 8 depicts a possible processing sequence and logic diagram 800 of the Advance View Limiting Device 500. FIG. 8 includes a Smart Device Application 802, an AGA Unit 510, a processing unit 806, and the AR goggles 505. As illustrated in FIG. 8, the AGA unit 510 provides real-time wind information as well as position, altitude, ground speed, attitude and heading data of the aircraft being flown through the use of, for example, a Global Positioning System (GPS) 808, an attitude heading reference system (AHRS) 810, and an Automatic Dependent Surveillance Broadcast (ADS-B) 812. The GPS 808 may provide an altitude 814, and a position 816 such as a longitude and latitude. The GPS 808 may also be able to provide ground speed derived from real time latitude and longitude information. The AHRS-1 810 device may provide a pitch 818, roll 820, and yaw 822 of the aircraft. The ADS-B 812 may provide ground speed 824 and wind speed 826. Therefore, in different embodiments, the ground speed can be received either from the GPS 808 or the ADS-B 812. The information from the AGA Unit 510 is preferably provided to the processing unit-1 806. The processing unit-1 806 will receive this information via, preferably, a short-range wireless communication protocol like Wi-Fi or Bluetooth. The processing unit-1 806 monitors the real-time Altitude data 814 received from the GPS 808 portion of AGA 510 and compares that data to the altitude set points (top & ceiling) that are defined by the user through the smart device application 802 to determine whether or not the aircraft is within the defined vertical boundaries of the defined volumetric space. The processing unit-1 806 may also monitor the real time GPS 808 coordinate 816 values and compare them to the desired geographical boundaries (also defined by the user through the smart device application 802) to determine whether or not the aircraft is within the geographical boundaries of the defined volumetric space. The processing unit-1 806 may use the altitude and coordinate criteria combined to decide whether it should fade-in, or fade-out the augmented images 405 from the central vision to far peripheral vision or vice versa, depending on whether the aircraft is entering or exiting the defined volumetric space.

In one embodiment, the processing unit-1 806 may also compute the aircraft's airspeed 830 given the combination of ground speed 824 and wind speed 826 provided by the ADS-B 812 portion of AGA 510. Some ADS-B systems provide real-time airspeed value. In that case, AVLD 500 can directly receive the airspeed value from ADS-B without performing any calculations. In any case, the airspeed value may be used to control the play speed of the augmented images 405 such that it will seem most natural to the eye of the student 105. The aircraft's Pitch 818, Roll 820, and Yaw 822 information provided by the AHRS-1 portion 810 of the AGA Unit 510 is received and may be processed by the processing unit-1 806 to adjust the orientation of the augmented images 405. Hence, if the aircraft's roll 820, pitch 818 or yaw 822 changes, the processing unit-1 806 may make necessary pitch, role, or yaw adjustments to the augmented images 405 such that it will seem most natural to the eye of the student 105. As one example and without limitation, if augmented images of cloud being shown and the aircraft is flying above the top of the cloud, the cloud layer would seem to be beneath the aircrafts and being stationary with respect to ground (assuming there is no wind) Hence, if the aircraft turns 90 degrees to the right, the images of the overcast cloud beneath the aircraft should turn 90 degrees to the left in order to seam stationary to the eye of the student. Respectively any change in the aircraft's attitude, altitude, and heading will be compensated by adjusting the augmented images such that the student observes the clouds stationary with respect to ground. Wind data 826 provided by ADS-B 812 portion of AGA unit 510 can also be incorporated into adjustments of augmented images in order to create the most realistic experience. Preferably the AGA unit 510 is attached to a stationary point inside the aircraft in order to accurately provide the attitude and heading references. For example, the AGA unit 510 can be mounted on the rear side window by a suction cup. Once the image processing unit of the processing unit-1 806 has made all the necessary adjustments mentioned above, the augmented images 405 may be sent to the AR goggles 505 for further processing.

Some aircraft's avionics systems allow communication to be established between an external device and aircraft's avionics. In this case, the AR goggles 505 can receive information including but not limited to aircraft's altitude, attitude, heading, airspeed, ground speed, and geographical coordinates, from the aircraft's avionics. This will provide more accurate information to the goggles as well as providing more convenience for the user by eliminating need for the external AGA unit 510. However, the AGA unit 510 is needed in case the aircraft being flown is not equipped with advance avionics with capabilities described above.

The AR goggles 505 receive the processed images and may make additional adjustments to incorporate the effects of the student's 105 head movements. The information provided by AHRS-2 may be used by the AR goggles' 505 processing unit-2 to determine what augmented images 405 must be shown within the user's field of view at any given time and how the images need to be positioned and oriented proportional to student's head movement. For example, and without limitation, images of rain particles should look differently when the student's 105 head is oriented so that he/she would be looking out of the front windshield vs the student's 105 head is oriented so that he/she would be looking out of one of the side windows.

After the final stage of image processing is done, preferably three copies of the fully processed images 405 will be generated. The first copy will preferably be sent to the AR goggles' 505 display where the student 105 can experience the fully processed images 405. Preferably, the second copy will be stored in the AR goggles' memory 505 (or a similar memory located outside of the AR goggles 505) for educational and debriefing purposes at a later time. The third copy, preferably, will be sent as real time (on-demand) to the smart device 515. This is to provide a verification tool to the safety pilot 115 in order to be able to monitor the student's 105 view at any moment of time.

In case any of the AVLD's 500 components fails or malfunctions during the operation, the AR goggles 505 can easily be removed and flight can be safely continued under VFR conditions.

FIGS. 10A and 10B illustrates one manner in which the invention only presents the augmented images in the appropriate locations on the goggle's display. FIG. 10A illustrates the limits of where the augmented image will be displayed to the student 105 along the pitch axis. The “outside view” 1010 is a portion of student's view 1005 where outside can be seen through the goggles in the absences of augmented images. The augmented image is only displayed to the student 105 over the arc indicated by reference number 1010. In other words, when the student 105 is looking outside the aircraft 1010 the augmented image is displayed. When the student 105 is looking inside the aircraft, for instance at the ceiling of the aircraft 1015 or at the instrument panel 1020, the student 105 would see either the ceiling or the instrument panel respectively.

FIG. 10B. illustrates the limits of where the augmented image will be displayed to the student 105 along the yaw axis. The total view of the student's view is indicated by reference number 1025. The portions of the student's view where the augmented image will be displayed are shown by reference numbers 1030, 1035 and 1040. The portions of the student's view where the inside of the cockpit will be shown are indicated by reference numbers and 1045 and 1050.

One of the key differences between AVLD 500 and other aviation AR goggles is that the current goal of all current aviation AR glasses is to provide Enhanced Vision to the pilot for better situational awareness. On the other hand, the goal of the AVLD 500 is to provide Purposeful Reduced Vision to the student 105 to enhance their piloting skills under instrument conditions.

The advantages of the AVLD 500 in comparison with conventional view limiting devices include:
1) The AVLD 500 has the visual advantages of a ground-based simulator combined with tangible experience of flying an aircraft. This creates a unique opportunity that can improve pilot's response against spatial disorientation.
2) AVLD 500 allows instrument training and evaluation to be conducted with zero chances of cheating (intentionally or unintentionally) and results in the development of stronger pilot skills under IMC.
3) The CFII or DPE does not have to deal with limitations or responsibilities associated with Instrument flight Rules (IFR) to provide IMC experience to the student 105.
4) The CFII or DPE can explore the student's 105 recovery skills on stall, spin, lost procedure, or simulated engine failure in simulated IMC provided by AVLD which is currently a huge gap in conventional instrument training methods.
5) The AVLD 500 allows simulated IMC experience to be possible on demand and independent of weather conditions while flying an actual aircraft.
6) Unlike the conventional view limiting devices that do not allow the student 105 to experience distraction caused by moving particles towards the front screen, AVLD 500 creates a challenging environment similar to the one that the pilots can experience in IMC conditions. This realistic looking experience may help pilots to improve their focusing skills and instrument scanning techniques.
7) AVLD 500 allows practice approaches to minimum and missed approaches in IMC to be fully tangible for students.

Future Generations of the AVLD may employ mixed reality goggles as an alternative to augmented reality goggles and may include an embedded GPS, ADS-B, and a digital altimeter within the goggles.

Other variations of AVLD can be developed to visually simulate symptoms of various system malfunctions or failures that can occur outside of the aircraft such as Smoke or fire coming out of the engine, wing fire, Icing and other types of inflight failures and hazards. These features can be added by the instructor during the flight at any moment in order to evaluate the response of the student 105.

### List of Abbreviations

ADS-B Automatic Dependent Surveillance Broadcast
AGA ADS-B, GPS, AHRS Unit
AHRS Attitude, Heading Reference System
ATC Air Traffic Controller
AVLD Advance View Limiting Device
CFII Certified Flight Instructor for Instrument
DPE Designated Pilot Examiner
GPS Global Positioning System
IFR Instrument Flight Rules
IMC Instrument Meteorological Condition
MSL Mean Sea Level
PIC Pilot in Command
VFR Visual Flight Rules
VMC Visual Meteorological Condition
Wi-Fi Wireless Fidelity

What is claimed is:

1. A method of presenting augmented images on augmented reality goggles, said method comprising the steps of:
accessing defined augmented images of weather phenomenon, receiving desired geographical boundaries and desired altitude boundaries;
using said geographical boundaries, and said altitude boundaries to determine a defined volumetric space; receiving three-dimensional location information related to position of an aircraft in operation; wherein said augmented reality goggles are located inside the aircraft;
determining that said three-dimensional location information is positioned within said defined volumetric space; and
displaying augmented images on said augmented reality goggles.

2. The method of presenting augmented images on augmented reality goggles of claim 1 wherein said augmented images are one of recorded videos or high-definition computer generated images.

3. The method of presenting augmented images on augmented reality goggles of claim 1 wherein said weather phenomenon is including but not limited to cloud, fog, sleet, hail, rain, snow, extreme darkness, or combination of one or more weather phenomenon.

4. The method of presenting augmented images on augmented reality goggles of claim 1 wherein said augmented images illustrates visibility which is less than the actual visibility outside the aircraft.

5. The method of presenting augmented images on augmented reality goggles of claim 1 wherein said three-dimensional location information is provided by aircraft's avionics or a global positioning system

6. The method of presenting augmented images on augmented reality goggles of claim 1 wherein areas or surfaces which through those areas or surfaces, outside of an aircraft can be seen from inside the aircraft are being detected and tracked.

7. The method of presenting augmented images on augmented reality goggles of claim 1 wherein user's view through the areas or surfaces which through those areas or surfaces, outside of an aircraft can be seen from inside the aircraft is replaced with the augmented images.

8. The method of presenting augmented images on augmented reality goggles of claim 1 wherein said step of determining that said three-dimensional location information is positioned within said defined volumetric space comprises the step of comparing the longitude, latitude and altitude information of three-dimensional location information of the aircraft with location information of said defined volumetric space.

9. The method of presenting augmented images on augmented reality goggles of claim 1 wherein said augmented reality goggles are worn by a pilot for the purpose of one of instrument training, instrument flying practice or instrument flying skills evaluation.

10. A method of presenting an “outside the aircraft” view on augmented reality goggles, said method comprising of the steps of:
accessing the user defined augmented images of a weather phenomenon, receiving desired geographical boundaries and desired altitude boundaries;
using said desired geographical boundaries and desired altitude boundaries to determine a defined volumetric space; receiving three-dimensional location information related to position of the aircraft in operation;
wherein said augmented reality goggles are located inside the aircraft;
determining that said three-dimensional location is not positioned within said defined volumetric space; and
displaying an augmented image on said augmented reality goggles.

11. The method of presenting an “outside the aircraft” view on augmented reality goggles of claim 10 wherein said augmented images are one of recorded videos or high-definition computer generated images.

12. The method of presenting augmented images on augmented reality goggles of claim 1 wherein said augmented reality goggles are worn by a pilot for the purpose of one of instrument training, instrument flying practice or instrument flying skills evaluation.

13. The method of presenting augmented images on augmented reality goggles of claim 1 wherein said augmented images illustrates visibility which is less than the actual visibility outside the aircraft.

14. The method of presenting augmented images on augmented reality goggles of claim 1 wherein said three-dimensional location information is provided by aircraft's avionics or a global positioning system

15. An advanced view limiting device comprising:
augmented reality goggles located inside an aircraft,
an Automatic Dependent Surveillance Broadcast (ADS-B),
a Global Positioning System (GPS),
an Attitude, Heading Reference System (AHRS), and
a processing unit
wherein said processing unit accesses the user defined augmented images of a weather phenomenon, desired geographical boundaries and desired altitude boundaries using said geographical boundaries and altitude boundaries to determine a defined volumetric space,
wherein said processing unit receives data from said GPS, or said aircraft's avionics and said processing unit uses data received from said GPS or said aircraft's avionics to determine if said aircraft is located within said defined volumetric space, and
if said aircraft is located within said defined volumetric space to use said augmented images of the weather phenomenon to present the augmented images on said augmented reality goggles.

16. The method of presenting augmented images on augmented reality goggles of claim 1 wherein said augmented images are one of recorded videos or high-definition computer generated images.

17. The method of presenting augmented images on augmented reality goggles of claim 1 wherein said weather phenomenon is including but not limited to cloud, fog, sleet, hail, rain, snow, extreme darkness, or combination of one or more weather phenomenon.

18. The method of presenting augmented images on augmented reality goggles of claim 1 wherein said augmented images illustrates visibility which is less than the actual visibility outside the aircraft.

19. The method of presenting augmented images on augmented reality goggles of claim 1 wherein said three-dimensional location information is provided by aircraft's avionics or a global positioning system

20. The method of presenting augmented images on augmented reality goggles of claim 1 wherein said augmented reality goggles are worn by a pilot for the purpose of one of instrument training, instrument flying practice or instrument flying skills evaluation.
